(19) United States
(12) Patent Application Publication
(10) Pub. No.: US 2011/0266071 A1
(43) Pub. Date: Nov. 3, 2011

(54) Rotary Drill Bits with Optimized Fluid Flow Characteristics

(76) Inventor: William H. Lind, The Woodlands, TX (US)

(21) Appl. No.: 13/144,230

(22) PCT Filed: Jan. 13, 2010
(86) PCT No.: PCT/US2010/020909

§ 371 Date: Jul. 12, 2011

Related U.S. Application Data
(60) Provisional application No. 61/144,562, filed on Jan. 14, 2009.
(60) Provisional application No. 61/178,394, filed on May 14, 2009.

(51) Int. Cl. E21B 10/36; G06G 7/50

(52) U.S. Cl. 175/428; 703/9

(57) ABSTRACT

According to one embodiment, a rotary drill bit comprises a bit body with a bit rotational axis extending through the bit body; blades disposed outwardly from exterior portions of the bit body; and cutting elements disposed outwardly from exterior portions of each blade. At least one blade has a substantially arched configuration. Each blade comprises a leading surface and a trailing surface, where the leading surface is disposed on the side of the blade toward the direction of rotation of the rotary drill bit, and the trailing surface is disposed on the side of the blade opposite to the direction of rotation of the rotary drill bit. The rotary drill bit also comprises junk slots. Each junk slot is disposed between an adjacent leading surface and an adjacent trailing surface of associated blades.

### RELATED APPLICATIONS

This application claims benefit under 35 U.S.C. §119(e) of U.S. Provisional Application Ser. No. 61/144,562, entitled “ROTARY DRILL BITS AND OTHER WELL TOOLS WITH FLUID FLOW PATHS OPTIMIZING DOWNHOLE DRILLING PERFORMANCE,” Attorney's Docket 074263.0486, filed Jan. 14, 2009; and U.S. Provisional Application Ser. No. 61/178,394, entitled “ROTARY DRILL BITS AND OTHER WELL TOOLS WITH FLUID FLOW PATHS OPTIMIZING DOWNHOLE DRILLING PERFORMANCE,” Attorney's Docket 074263.0486 (074263.0517), filed May 14, 2009, which are incorporated herein by reference.

### TECHNICAL FIELD

The present disclosure relates generally to rotary drill bits and more specifically to drill bits with optimized fluid flow characteristics.

### BACKGROUND OF THE DISCLOSURE

Various types of rotary drill bits may be used to form a borehole in the earth. Examples of such rotary drill bits include, but are not limited to, fixed cutter drill bits, drag bits, PDC drill bits, matrix drill bits, roller cone drill bits, rotary cone drill bits, and rock bits used in drilling oil and gas wells. Cutting action associated with such drill bits generally requires weight on bit (WOB) and rotation of associated cutting elements into adjacent portions of a downhole formation. Drilling fluids supplied to such rotary drill bits may perform several functions including, but not limited to, removing formation materials and other downhole debris from the bottom or end of a wellbore, cleaning associated cutting elements and cutting structures, and carrying formation cuttings and other downhole debris upward to an associated well surface.

### SUMMARY OF THE DISCLOSURE

According to one embodiment, a rotary drill bit comprises a bit body with a bit rotational axis extending through the bit body; blades disposed outwardly from exterior portions of the bit body; and cutting elements disposed outwardly from exterior portions of each blade. At least one blade has a substantially arched configuration. Each blade comprises a leading surface and a trailing surface, where the leading surface is disposed on the side of the blade toward the direction of rotation of the rotary drill bit, and the trailing surface is disposed on the side of the blade opposite to the direction of rotation of the rotary drill bit. The rotary drill bit also comprises junk slots. Each junk slot is disposed between an adjacent leading surface and an adjacent trailing surface of associated blades. At least one blade has at least one contour on the leading surface of the blade, the trailing surface of the blade, or both the leading surface and the trailing surface of the blade.

According to one embodiment, a rotary drill bit comprises a bit body with a bit rotational axis extending through the bit body; blades disposed outwardly from exterior portions of the bit body; and cutting elements disposed outwardly from exterior portions of each blade. At least one blade has a substantially arched configuration. Each blade comprises a leading surface and a trailing surface, where the leading surface is disposed on the side of the blade toward the direction of rotation of the rotary drill bit, and the trailing surface is disposed on the side of the blade opposite to the direction of rotation of the rotary drill bit. The rotary drill bit also comprises junk slots. Each junk slot is disposed between an adjacent leading surface and an adjacent trailing surface of associated blades. At least one blade has at least one extension operable to optimize fluid-flow through an associated junk slot.

According to one embodiment, a rotary drill bit comprises a bit body with a bit rotational axis extending through the bit body; blades disposed outwardly from exterior portions of the bit body; and cutting elements disposed outwardly from exterior portions of each blade. At least one blade has a substantially arched configuration. Each blade comprises a leading surface and a trailing surface, where the leading surface is disposed on the side of the blade toward the direction of rotation of the rotary drill bit, and the trailing surface is disposed on the side of the blade opposite to the direction of rotation of the rotary drill bit. The rotary drill bit also comprises junk slots. Each junk slot is disposed between an adjacent leading surface and an adjacent trailing surface of associated blades. The rotary drill bit also comprises at least one nozzle disposed in at least one junk slot and at least one diffuser located on at least one of the blades proximate a nozzle. The diffuser is operable to optimize fluid-flow through an associated junk slot.

According to one embodiment, a method for optimizing fluid flow in a rotary drill bit includes determining at least one optimum location that may be modified on at least one blade of the rotary drill bit by performing at least one computational fluid dynamics (CFD) program simulation. A blade is modified at an optimum location to yield at least one modified blade. The modification modifies at least one dimension of at least one junk slot disposed between the modified blade and a blade adjacent to the modified blade to yield at least one modified junk slot. The modification changes the fluid flow pattern in the modified junk slot to optimize fluid flow of the drill bit.

Certain embodiments of the invention may provide one or more technical advantages. A technical advantage of one embodiment may be that fluid flow optimization may decrease wear and/or improve cleaning of components of a drill bit structures or other wellbore tools, which may increase the life of the tools. Another technical advantage of one embodiment may be that fluid flow optimization may also prevent accumulation of downhole debris, which may improve performance.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a schematic drawing in section and in elevation showing examples of wellbores that may be formed according to teachings of the present disclosure;

FIG. 2 is a schematic drawing showing an isometric view of an example embodiment of a fixed cutter rotary drill bit;

FIGS. 3A through 3G are schematic drawings showing end views of example embodiments of rotary drill bits;

FIG. 4A is a schematic drawing of computational fluid dynamics (CFD) modeling showing flow patterns of a drill bit with undesirable fluid flow characteristics;

FIG. 4B is a schematic drawing of computational fluid dynamics (CFD) modeling showing improved flow patterns;

FIGS. 5A through 5E are schematic drawings showing end views of example embodiments of rotary drill bits; and

FIG. 6 is a schematic drawing showing an example embodiment of a blade of a rotary drill bit.

### DETAILED DESCRIPTION OF THE DISCLOSURE

Overview

Various types of rotary drill bits associated with drilling wellbores may be formed in accordance with teachings of the present disclosure with exterior portions that optimize flow characteristics (hydraulics) of drilling fluids and other downhole fluids over exterior portions of such drill bits. For some embodiments, a plurality of fluid flow paths may be formed by exterior portions of a generally cylindrical bit body in accordance with teachings of the present disclosure. For example, fixed cutter rotary drill bits may be formed with a plurality of blades having fluid flow paths (also referred to as junk slots) disposed therebetween. The blades and associated fluid flow paths (or junk slots) may have symmetrical or asymmetrical configurations relative to each other and an associated generally cylindrical body.

I. Drilling System

In certain embodiments, a drilling system includes a rotary dill bit. The term “rotary drill bit” may be used in this application to include various types of fixed cutter drill bits, drag bits, matrix drill bits, and/or steel body drill bits operable to form a wellbore extending through one or more downhole formations. Rotary drill bits and associated components formed in accordance with teachings of the present disclosure may have many different designs, configurations, and/or dimensions.

In certain embodiments, one or more blades may be disposed outwardly from exterior portions of a rotary bit body, which may take a generally cylindrical form. The terms “blade” and “blades” may be used in this application to include, but are not limited to, various types of projections extending outwardly from a generally cylindrical body. For example, a portion of a blade may be directly or indirectly coupled to an exterior portion of a generally cylindrical body while another portion of the blade is projected away from the exterior portion of the cylindrical body. Blades formed in accordance with teachings of the present disclosure may have a wide variety of configurations including, but not limited to, substantially arched, helical, spiraling, tapered, converging, diverging, symmetrical, and/or asymmetrical. Various configurations of blades may be used to form cutting structures for a rotary drill bit incorporating teachings of the present disclosure. In some cases, the blades may have substantially arched configurations, generally helical configurations, spiral shaped configurations, or any other configuration satisfactory for use with each downhole tool.

One or more blades may substantially have an arched configuration extending from proximate the bit rotational axis such that the arched configuration may be defined in part by a generally concave, recessed shaped portion extending from proximate the bit rotational axis and a generally convex, outwardly curved portion disposed between the concave, recessed portion and exterior portions of each blade which correspond generally with the outside diameter of the rotary drill bit.

An embodiment of a drill bit may comprise a plurality of primary blades disposed generally symmetrically about the bit rotational axis. For example, one embodiment may comprise three primary blades oriented approximately 120 degrees relative to each other with respect to the bit rotational axis. The primary blades may provide stability. An embodiment may also comprise at least one secondary blade disposed between primary blades. The number and location of secondary blades and primary blades may vary substantially. The blades may be disposed symmetrically or asymmetrically with regard to each other and the bit rotational axis, such disposition preferably based on the downhole drilling conditions of the drilling environment.

A blade of the present disclosure may comprise a first end disposed proximate or toward an associated bit rotational axis and a second end disposed proximate exterior portions of the rotary drill bit (i.e., disposed generally away from the bit rotational axis and toward uphole portions thereof). Each blade may comprise a leading surface disposed on one side of the blade in the direction of rotation of a rotary drill bit and a trailing surface disposed on an opposite side of the blade away from the direction of rotation of the rotary drill bit. A junk slot may be disposed between associated blades, i.e., a first blade and the blade that follows the first blade during rotation of the rotary drill bit. Thus, a junk slot may be disposed between a trailing surface of the first blade and a leading surface of the following blade.

A plurality of cutting elements may be disposed outwardly from exterior portions of each blade. For example, a portion of a cutting element may be directly or indirectly coupled to an exterior portion of a blade while another portion of the cutting element is projected away from the exterior portion of the blade.

The term “cutting structure” may be used in this application to include various combinations and arrangements of cutting elements, impact arrestors, and/or gage cutters disposed on exterior portions of a rotary drill bit. Some rotary drill bits may include one or more blades extending from an associated bit body with cutting elements disposed thereon. Such blades may also be referred to as “cutter blades.” Various configurations of blades and cutting elements may be used to form cutting structures for a rotary drill bit.

The terms “cutting element” and “cutting elements” may be used in this application to include, but are not limited to, various types of cutters, compacts, buttons, inserts, and gage cutters satisfactory for use with a wide variety of rotary drill bits. Impact arrestors may be included as part of the cutting structure on some types of rotary drill bits and may sometimes function as cutting elements to remove formation materials from adjacent portions of a wellbore. Polycrystalline diamond compacts (PDC) and tungsten carbide inserts are often used to form cutting elements. Various types of other hard, abrasive materials may also be satisfactorily used to form cutting elements.

The term “gage pad” as used in this application may include a gage, gage segment, or gage portion disposed on exterior portion of a blade. Gage pads may often contact adjacent portions of a wellbore formed by an associated rotary drill bit. Exterior portions of blades and/or associated gage pads may be disposed at various angles, either positive, negative, and/or parallel, relative to adjacent portions of a straight wellbore. A gage pad may include one or more layers of hardfacing material. One or more gage pads may be disposed on a blade.

The term “bottom hole assembly” or “BHA” may be used in this application to describe various components (including assemblies) disposed proximate a rotary drill bit at the downhole end of a drill string. Examples of components that may be included in a bottom hole assembly include, but are not limited to, bent subs, downhole drilling motors, reamers, stabilizers, sleeves, rotary steering tools, and downhole instruments. Components located proximate an associated rotary drill bit may sometimes be referred to as “near bit”, such as near bit reamers, near bit stabilizers, or near bit sleeves.

A bottom hole assembly may also include various types of well logging tools and other downhole tools associated with directional drilling of a wellbore. Examples of such downhole tools may include, but are not limited to, acoustic, neutron, gamma ray, density, photoelectric, nuclear magnetic resonance, measuring while drilling (MWD) tools, and/or other commercially available well tools.

The terms “downhole” and “uphole” may be used in this application to describe the location of various components of a bottom hole assembly and associated rotary drill bit relative to portions of the rotary drill bit which engage the bottom or end of a wellbore to remove adjacent formation materials. For example, an “uphole” component may be located closer to an associated drill string as compared to a “downhole” component which may be located closer to the bottom or end of the wellbore.

II. Modifications

In some embodiments, portions of the drill bit (or other downhole tools such as reamers, hole openers, and/or stabilizers) may yield an optimized fluid flow. The portions may be modified (such as designed) to yield such optimized fluid flow. Portions may include blades, nozzles, diffusers, and combinations thereof.

“Modifying” a component may refer to modifying an abstract design of the component (and perhaps creating the component according to the design) or modifying the physical component itself. For example, a blade may be modified by modifying an abstract design of the blade (and perhaps creating the blade according to the design) or modifying the blade itself.

As used in this application, “optimum” and “optimize” may refer to an improved feature, which may or may not be the best possible feature. For example, when referring to fluid flow, “optimum” and “optimize” may refer to an improved fluid flow, which may or may not be the best fluid flow. Similarly, when describing a location of the rotary drill bit, “optimum” and “optimize” may refer to an improved location which may or may not be the best location.

In some embodiments, blade features, such as blade geometry, configuration, orientation, and/or location, may yield an optimized fluid flow. The blade features may be modified to yield such flow. Modifications to a blade may be made at one or more locations on a leading surface, a trailing surface, or both. Modifications may be proximate the first end of the blade, the second end of the blade, or anywhere there-between.

In some embodiments, blade features may be modified at one or more optimum locations on a blade to form at least one modified blade and at least one modified junk slot. This modification may result in optimized fluid flow in at least one modified junk slot adjacent to the modified blade, which may yield an improved pattern of the fluid flow (fluid flow pattern), within the modified junk slot. In some embodiments, combinations of at least one protrusion and at least one recess on one or more blades may change the geometry of a junk slot disposed between two adjacent blades, thereby changing the flow of fluid in an associated junk slot or fluid flow path, where an associated junk slot is a junk slot adjacent to the blade or blades being referenced.

A modification to a blade may comprise adding a contour, such as a protrusion, a recess, a slope, or combinations thereof, to one or more locations and/or surfaces and/or edges of a blade. A protrusion may comprise a portion of the blade that is raised with respect to portions of the blade surrounding the raised portion of the blade. Examples of a protrusion may comprise a convex projection, a protuberance, a bump, a hump, an extension, the like, or any combination thereof. A recess may comprise a portion of the blade that is lowered with respect to portions of the blade surrounding the lowered portion of the blade. Examples of a recess may comprise a cut, a cavity, a concave indentation, the like, or any combination thereof. A slope may comprise a portion of the blade that ascends or descends with respect to an adjacent portion of the blade. Examples of a slope may comprise a deep curve, a curve, a bend, an angle, an arc, an arch, a turn, a tilt, an inclination, an incline, a slant, the like, or any combination thereof.

In some embodiments, a surface of the blade, such as a leading surface or a trailing surface, may substantially lie in a common plane. Such a surface may be modified to contain a contour, where the contour is a portion of the blade surface that deviates from the common plane. In some embodiments, a portion of the surface of the blade may lie in a common plane, and a contour may comprise the remainder of the surface.

In some embodiments, a surface of the blade, such as a leading surface or a trailing surface, may have a common incline or curve along its length. Such a surface may be modified to contain a contour, where the contour is a portion of the blade surface that deviates from the common incline or curve of the surface to form a protrusion, recess, or incline of the surface.

In some embodiments, at least one contour may be formed on a leading surface of a blade, or on a trailing surface of a blade, or on both the leading and trailing surfaces of a blade. Examples of contours on blades include a protrusion on a trailing surface, a protrusion on the leading surface, a recess on a trailing surface, a recess on the leading surface, a slope on a trailing surface, a slope on the leading surface, a recess or a curve on the trailing surface and a protrusion on the leading surface, a recess or a curve on both the leading and trailing surfaces, a hump or a protrusion on both the leading and trailing surfaces, and/or a recess or a curve and a hump or a protrusion on both the leading and trailing surfaces, any combinations thereof, and other configurations.

A modification to a blade may comprise modifying an angle at which a blade is placed with respect to the bit rotational axis of the bit body. The bit rotational axis runs generally through the center of the bit body and is the axis about which the bit turns during drilling. In some embodiments, a blade may be modified by changing the blade angle.

In some embodiments, a change in the angle of a blade may cause a blade to extend and/or protrude and/or slope upward/downward. The angle may also change the direction of a blade. For example, a blade may extend toward the center of a drill bit, a blade may extend away from the center of a drill bit, or a blade may be aligned to the right or the left of an associated bit rotational axis. In some embodiments, a change in blade angle may cause a blade to retreat, dip, incline, or slope.

In some embodiments, nozzle features, such as number, location, and/or orientation of nozzles, may yield an optimized fluid flow, such as optimized fluid flow through junk slots. The nozzle features may be modified to yield such flow. Fixed cutter drill bits may be configured with one or more nozzle exits spaced along the exterior portions of a drill bit or a wellbore tool. Fluid from a nozzle may impact a downhole formation thereby removing rock cuttings and debris. A nozzle may be used in a fixed cutter drill bit at or near the center of a drill bit, or around the peripheral edge of a bit, to facilitate cone cleaning by removing debris from a borehole bottom and/or to cool the face of a drill bit. The number, orientation, configuration, and location of nozzles on a blade may be changed to improve fluid flow. In some embodiments, at least one nozzle may be disposed in at least one junk slot.

In some embodiments, diffuser features may yield an optimized fluid flow, such as optimize fluid flow through junk slots. The diffuser features may be modified to yield such flow. In accordance with the teachings of this disclosure, one or more diffusers may be formed and/or placed at optimum locations on portions of one or more blades which may serve to optimize fluid flow exiting from a nozzle.

For some applications, a diffuser may be used to direct fluid into a junk slot or away from a junk slot. Diffusers may be used to direct fluid flow towards a cutting surface or away from a cutting surface. In some embodiments, a diffuser may be used to enhance fluid flow or enhance the turbulence of fluid flow to one or more elements of a drill bit or a wellbore tool that require cleaning. Various configurations of nozzles, such as, but not limited to, to jet nozzles, may be used in conjunction with a diffuser to enhance cone cleaning, protection against bit balling, and increased total flow of drilling fluid through a drill bit without creating washout problems.

In certain cases, portions of a blade disposed adjacent to an associated nozzle may be formed to operate as a diffuser. Fluids exiting from the nozzle may have optimum flow characteristics (volume, rate, pressure, and the like) in an optimum direction relative to the associated nozzle to either enter an associated junk slot or to flow away from an associated junk slot. Diffusers may be formed to direct cutting features (the flow of drilling fluids towards or away from associated cutting elements and/or cutting surfaces).

In some embodiments, changing blade geometry, in combination with forming or placing one or more diffusers at optimum locations, may optimize downhole performance. In some embodiments, changing the configuration, geometry, or placement of a junk slot as well as forming and/or placing one or more diffusers proximate to nozzles may change a fluid flow.

III. Optimized Fluid Flow

Drill bit structures may yield fluid flow optimized for any suitable purpose, such as for cleaning, reducing erosion of drill bit structures, preventing balling, preventing accumulation of downhole cuttings, and/or any combination thereof. Fluid flow may be optimized by enhancing the flow, increasing or decreasing flow volume and/or pressure, changing direction of the flow, reducing or eliminating turbulent flow and/or eddy currents, obtaining a streamlined and/or laminar flow, and/or any combination thereof. The direction of the fluid flow may be changed in any suitable manner. For example, fluid flow may be directed into a junk slot, away from a junk slot, towards a cutting surface, away from a cutting surface, and/or combinations thereof.

In certain embodiments, turbulent flows or eddy currents are often formed in drill bits (or other wellbore tools) as a result of fluid flow. These turbulent flow patterns may cause wear, abrasion, and/or erosion of drill bits and cutting elements. Turbulent flow patterns may also result in recirculation of drilling mud and cuttings, which may prevent lifting of the cuttings to the well surface, which may also increase wear of the rotary drill bit. The terms erosion, abrasion, and/or wear may be used interchangeably herein to include any erosion, abrasion, or wear of the drill bits or components during drilling. Other factors that can cause erosion may include non-linear fluid flow, rapid fluid flow, abrasive downhole fluids, downhole liftings, and combinations thereof.

In some embodiments, modifications may yield slower fluid flow, which may approach a laminar flow. This may substantially reduce or eliminate turbulent fluid flow and resulting eddy currents in junk slots, which may reduce wear and erosion, and/or extend the life of drill bits and cutters. Slower fluid flow may allow for better utility of the fluid flow for cleaning exterior portions of drill bits and/or cleaning downhole debris.

In certain embodiments, blades may be designed such that fluid flow may be directed to elements of a drill bit (or to other downhole tools and components) that require cleaning. In some instances, fluid flow may be directed to wash away downhole debris. In some instances, fluid pressure may be controlled to wash debris or clean associated structures of a drill bit. Improved cleaning may result in faster or more thorough cleaning of drill elements and/or less debris accumulation on a portion of the drill bit, thus increasing contact between the rotary drill bit elements and downhole formation material.

In certain examples, optimized fluid flow may perform one or more of the following: direct fluid to structures on exterior portions of a drill bit or any wellbore tool to remove downhole debris, direct fluid from structures on interior portions of a drill bit or any wellbore tool to remove downhole debris accumulated on exterior portions, enhance lifting of formation cuttings, and improve cleaning of cutting structures associated with drilling. For example, enhanced lifting of formation cuttings may increase the speed at which formation cuttings are lifted uphole, increase the volume of formation cuttings lifted uphole, or allow the lifting of heavier formation cuttings.

Other examples of optimized fluid flow may include, but are not limited to, a fluid flow that has reduced turbulence, a streamlined fluid flow, a fluid flow with a controlled direction and/or rate and/or pressure of fluid flow, a fluid flow that cleans drill bit structures and/or prevents or reduces buildup of downhole cuttings, and/or a fluid flow that reduces or prevents wear due to erosion and/or abrasion.

IV. Analysis

Drill bit structures may be analyzed in any suitable manner, such as using computational fluid dynamics (CFD) and/or used drill bit analysis. The analysis may be used to determine areas of high erosion and/or high debris accumulation and/or locations to modify to optimize fluid flow.

The terms “computational fluid dynamics” and/or “CFD” may be used in this application to include various commercially available software programs and algorithms used to simulate and evaluate complex fluid interactions. CFD programs may be used with processors operable to perform simulations. Examples of CFD simulations may include calculation of heat and/or mass transfer, turbulence, velocity changes, and other characteristics associated with multiphase, complex fluid flow. Such fluids may often be a mixture of liquids, solids, and/or gases. Examples of processors operable to perform simulations include one or more computers, one or more microprocessors, one or more applications, and/or other logic. A CFD program may be stored in memory.

CFD simulations may be used in any suitable manner. For example, CFD simulations may be used to determine one or more optimum locations on one or more blades to change the geometry of one or more blades (and junk slots) to obtain optimized fluid flow based on the particular application or downhole formation. As another example, CFD simulations may be used to reveal problem locations associated with cleaning cutting elements, which may result in balling proximate such cutting elements. As another example, CFD simulations may be used to determine optimum locations for forming and/or placing a diffuser proximate a nozzle on a portion of a blade.

In certain embodiments, CFD velocity profile programs may be used to analyze fluid flow dynamics of drill bits with modified blades. In some embodiments, repeated iterations of CFD simulations followed by blade modifications may be performed to optimize fluid flow paths.

CFD programs may take into account any suitable parameters of the drilling rig, such as the fluid flow for the type/size of pump of the drilling rig, the size of the drill bit, and/or the quantity of nozzles of a drill bit. For example, the CFD may accept these parameters as input parameters for simulations.

In some cases, the pump capacity of a drilling rig may affect the downhole performance of a drill bit. For example, larger pumps may increase fluid flow causing larger erosions as compared with smaller pumps. As another example, smaller pumps may be associated with balling. Drill bit “balling” may occur when the cuttings generated by a drill bit clog the junk slots and impede removal of downhole debris. In some cases, the drill bit size may affect downhole performance of a drill. For example, smaller drill bits such as, but not limited to, a drill bit having about 7⅞ inch or smaller diameter, may be associated with more erosion, while larger drill bits such as, but not limited to, a drill bit having about 12½ inch diameter or larger, may be associated with balling.

Testing drill bits in a field and/or scanning of used drill bits may indicate areas of high erosion or high debris accumulation. This information may then be used to determine locations for modification. For example, a drill bit may be tested in a field having certain borehole characteristics or certain types of formations. The tested drill bit may then be scanned using appropriate scanning tools for locations of wear/erosion or locations where downhole debris accumulates during drilling. Modification may be made such that the locations are less prone to wear and/or accumulation.

The term “digital scanning” may be used to describe a wide variety of equipment and techniques satisfactory for measuring exterior dimensions of a rotary drill bit and other well tools with a very high degree of accuracy and to create a three dimensional image of exterior portions of such well tools. The results of digital scanning may be used with other computer programs such as CFD programs and processors to evaluate fluid flow characteristics over exterior portions of such rotary drill bits and other downhole tools.

Some examples of digital scanning equipment and techniques are discussed in copending U.S. patent application Ser. No. 60/992,392, entitled “Method and Apparatus to Improve Design, Manufacture, Performance and/or Use of Well Tools,” filed Dec. 5, 2007. CFD programs are available from various vendors. One example of a CFD program satisfactory for use with the present invention is FLUENT, available from ANSYS, Inc. located in Canonsburg, Pa.

Various computer programs and computer models may be used to design blades, cutting elements, fluid flow paths, and/or associated rotary drill bits. Examples of such methods and systems which may be used to design and evaluate performance of cutting elements and rotary drill bits are shown in co-pending U.S. patent application Ser. No. 11/462,898, entitled “Methods and Systems for Designing and/or Selecting Drilling Equipment Using Predictions of Rotary Drill Bit Walk,” filed Aug. 7, 2006, co-pending U.S. patent application Ser. No. 11/462,918, entitled “Methods and Systems of Rotary Drill Bit Steerability Prediction, Rotary Drill Bit Design and Operation,” filed Aug. 7, 2006, and co-pending U.S. patent application Ser. No. 11/462,929, entitled “Methods and Systems for Design and/or Selection of Drilling Equipment Based on Wellbore Simulations,” filed Aug. 7, 2006. The previous co-pending patent applications and any resulting U.S. patents are incorporated by reference into this application.

The Drawings

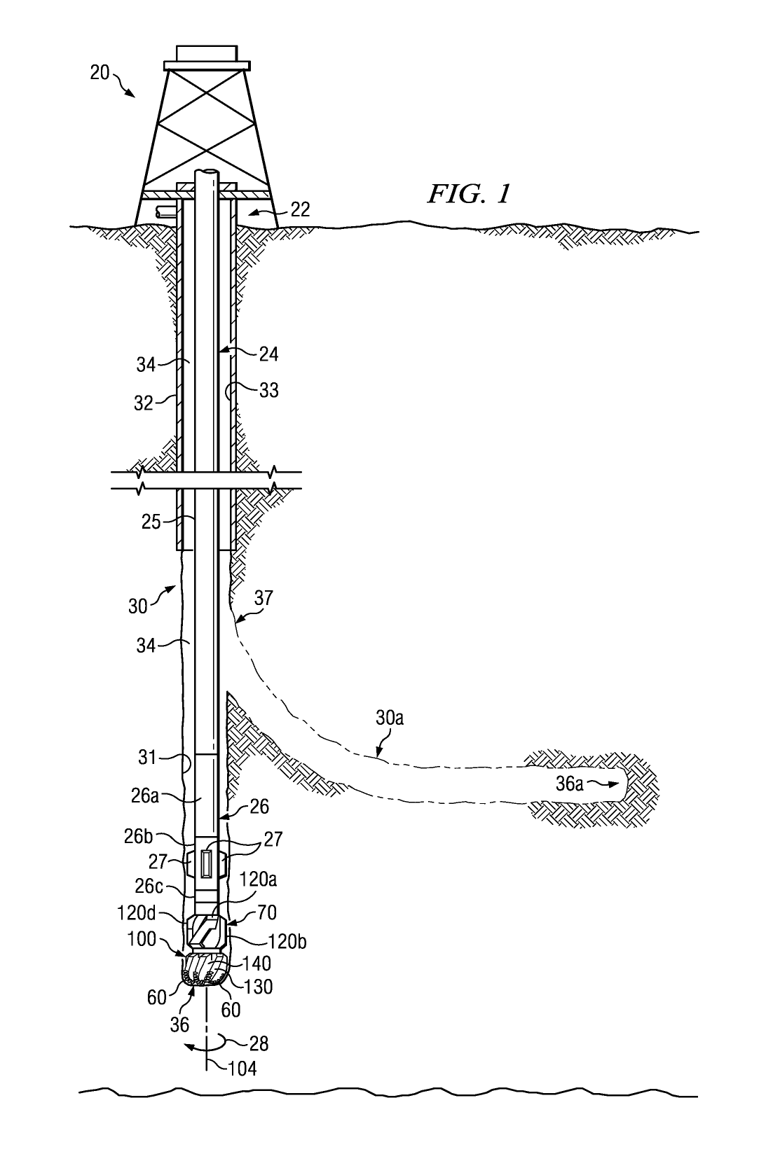

Various aspects of the present disclosure may be described with respect to rotary drill bit 100 as shown in FIGS. 1, 2, 3A, 3B, 3C, 3D, 3E, 3F, 3G, 4A, 4B, 5A, 5B, 5C, 5D, 5E, and 6. Rotary drill bit 100 may also be described as a fixed cutter drill bit. However, various aspects of the present disclosure may be used to design a wide variety of downhole tools having one or more blades. Roller cone or rotary cone drill bits may also be used with various downhole tools incorporating teachings of the present disclosure to optimize downhole drilling performance. The scope of the present disclosure is not limited to rotary drill bit 100.

FIG. 1 is a schematic drawing in elevation and in section with portions broken away showing examples of wellbores or bore holes which may be formed by rotary drill bits and other downhole tools such as sleeves or stabilizers incorporating teachings of the present disclosure. Cutting elements 60 may be disposed on exterior portions of blades 130. For some applications, blade features (e.g., the geometry, orientation, configuration, and/or contours) of one or more blades 130 may be changed to control and/or optimize and/or enhance fluid flow to and from junk slots to optimize downhole performance of a drill bit in accordance with the teachings of the present disclosure. Various aspects of the present disclosure may be described with respect to drilling rig 20, rotating drill string 24, bottom hole assembly 26 including sleeve or stabilizer 70, and associated rotary drill bit 100 to form a wellbore.

Various types of drilling equipment such as a rotary table, mud pumps, and mud tanks (not expressly shown) may be located at well surface or well site 22. Drilling rig 20 may have various characteristics and features associated with a “land drilling rig.” However, rotary drill bits incorporating teachings of the present disclosure may be satisfactorily used with drilling equipment located on offshore platforms, drill ships, semi-submersibles, and drilling barges (not expressly shown).

For some applications rotary drill bit 100 may be attached to bottom hole assembly 26 at an extreme end of drill string 24. Drill string 24 may be formed from sections or joints of generally hollow, tubular drill pipe (not expressly shown). Bottom hole assembly 26 will generally have an outside diameter compatible with exterior portions of drill string 24.

Bottom hole assembly 26 may be formed from a wide variety of components. For example, components 26a, 26b and 26c may be selected from the group consisting of, but not limited to, drill collars, rotary steering tools, directional drilling tools, and/or downhole drilling motors. The number of components such as drill collars and different types of components included in a bottom hole assembly will depend upon anticipated downhole drilling conditions and the type of wellbore which will be formed by drill string 24 and rotary drill bit 100.

Drill string 24 and rotary drill bit 100 may be used to form a wide variety of wellbores and/or bore holes such as generally vertical wellbore 30 and/or generally horizontal wellbore 30a as shown in FIG. 1. Various directional drilling techniques and associated components of bottomhole assembly 26 may be used to form horizontal wellbore 30a. For example, lateral forces may be applied to rotary drill bit 100 proximate kickoff location 37 to form horizontal wellbore 30a extending from generally vertical wellbore 30. Such lateral movement of rotary drill bit 100 may be described as “building” or forming a wellbore with an increasing angle relative to vertical. Bit tilting may also occur during formation of horizontal wellbore 30a, particularly proximate kickoff location 37.

Wellbore 30 may be defined in part by casing string 32 extending from well surface 22 to a selected downhole location. Portions of wellbore 30 as shown in FIG. 1 that do not include casing 32 may be described as “open hole.” Various types of drilling fluid may be pumped from well surface 22 through drill string 24 to attached rotary drill bit 100. The drilling fluid may be circulated back to well surface 22 through annulus 34 defined in part by outside diameter 25 of drill string 24 and inside diameter 31 of wellbore 30. Inside diameter 31 may also be referred to as the “sidewall” of wellbore 30. Annulus 34 may also be defined by outside diameter 25 of drill string 24 and inside diameter 33 of casing string 32.

Formation cuttings may be formed by rotary drill bit 100 engaging formation materials proximate end 36 of wellbore 30. Drilling fluids may be used to remove formation cuttings and other downhole debris (not expressly shown) from end 36 of wellbore 30 to well surface 22. End 36 may sometimes be described as “bottom hole” 36. Formation cuttings may also be formed by rotary drill bit 100 engaging end 36a of horizontal wellbore 30a.

Rate of penetration (ROP) of a rotary drill bit is typically a function of both weight on bit (WOB) and revolutions per minute (RPM). For some applications, a downhole motor (not expressly shown) may be provided as part of bottom hole assembly 26 to also rotate rotary drill bit 100. The rate of penetration of a rotary drill bit is generally stated in feet per hour. As shown in FIG. 1, drill string 24 may apply weight on and rotate rotary drill bit 100 to form wellbore 30. Inside diameter or sidewall 31 of wellbore 30 may correspond approximately with the combined outside diameter of blades 130 and associated gage pads 150 extending from rotary drill bit 100.

In addition to rotating and applying weight to rotary drill bit 100, drill string 24 may provide a conduit for communicating drilling fluids and other fluids from well surface 22 to drill bit 100 at end 36 of wellbore 30. Some drilling fluids may sometimes be referred to as drilling mud. Drilling fluids or other fluids flowing through drill string 24 may be directed to respective nozzles 56 of rotary drill bit 100. In accordance with the teachings of the present disclosure, diffusers may be formed (for example, by modifying a blade) and/or placed at one or more locations proximate nozzles for optimizing flow of drilling fluids. The number, orientation, and location of nozzles 56 may also be changed.

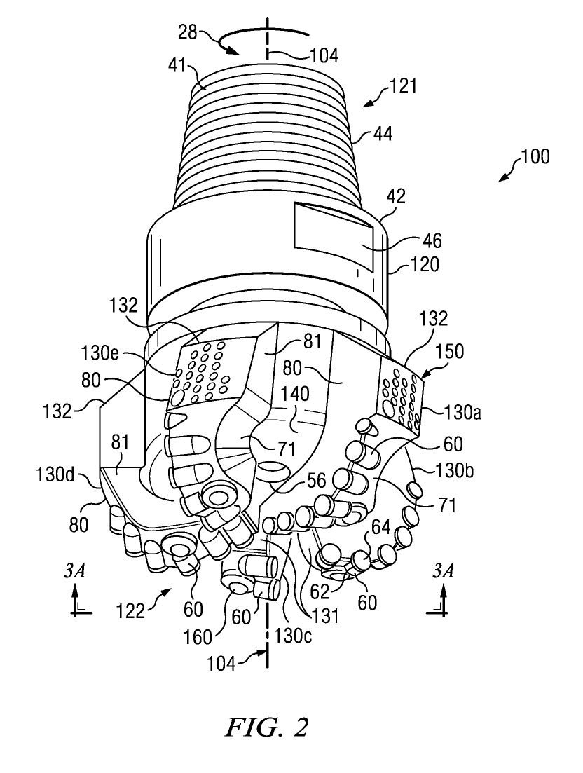

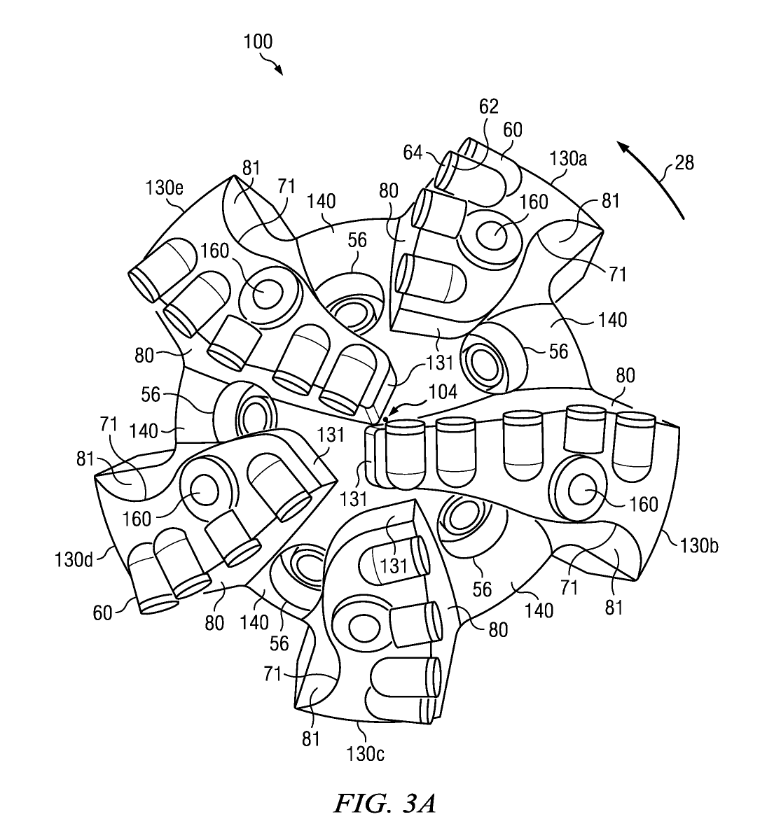

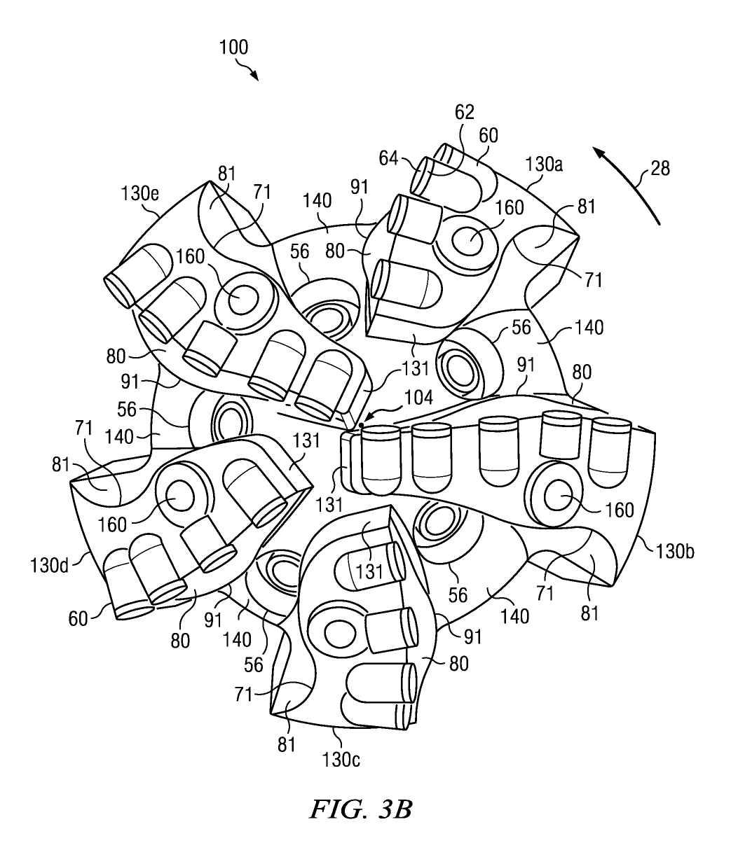

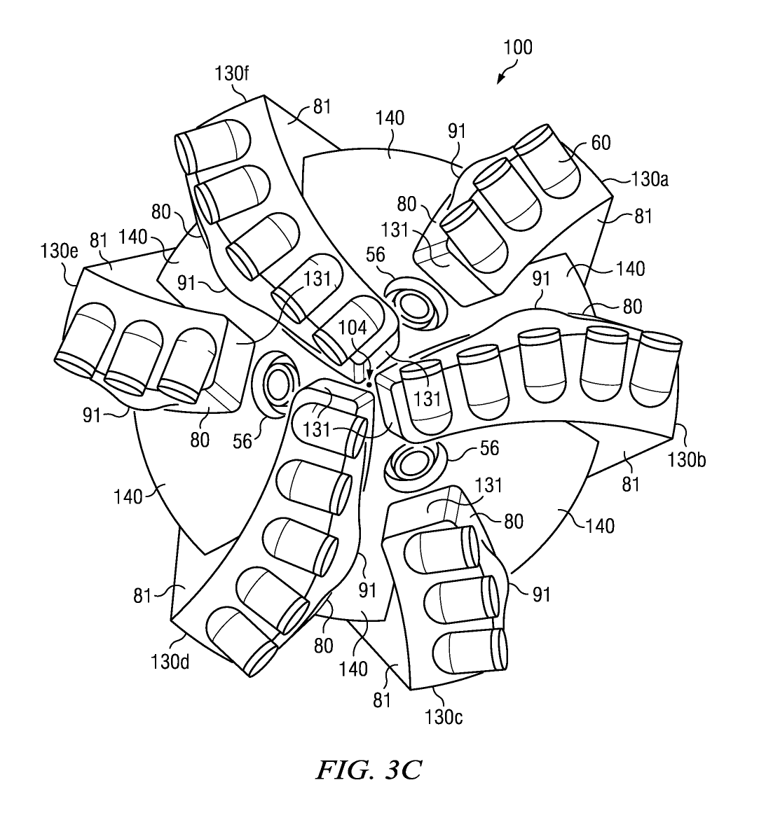

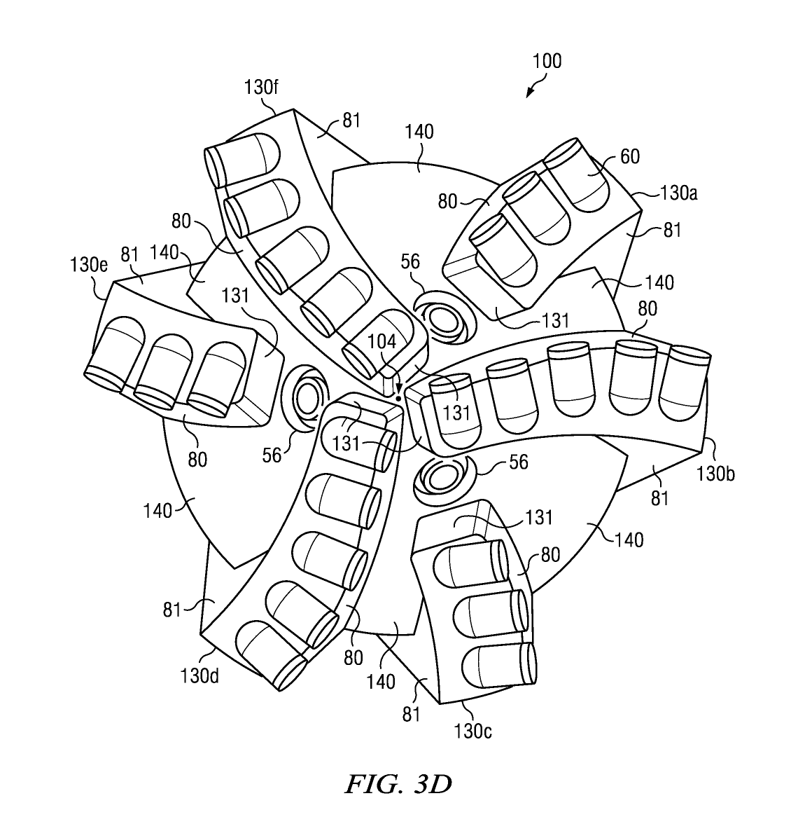

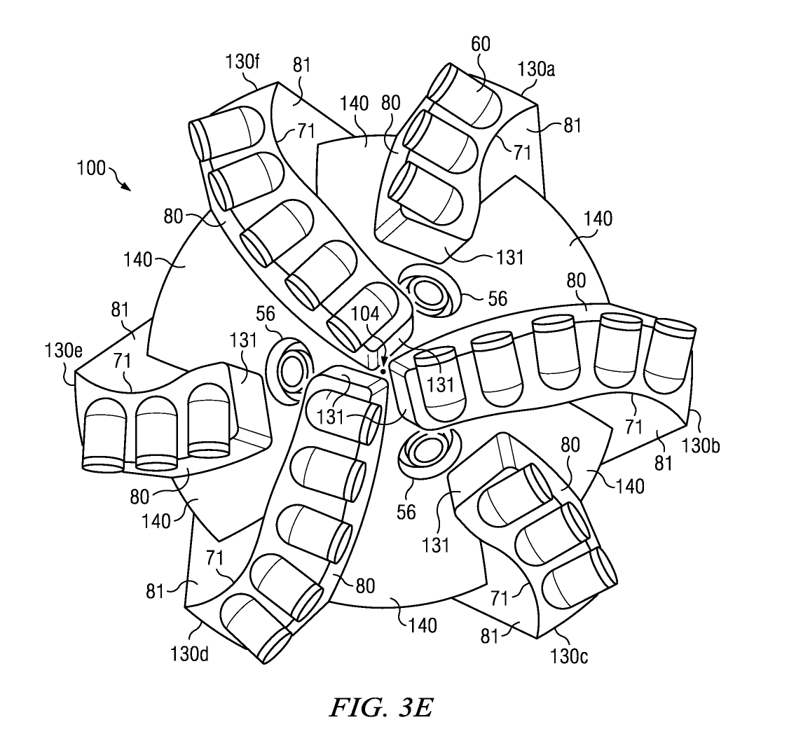

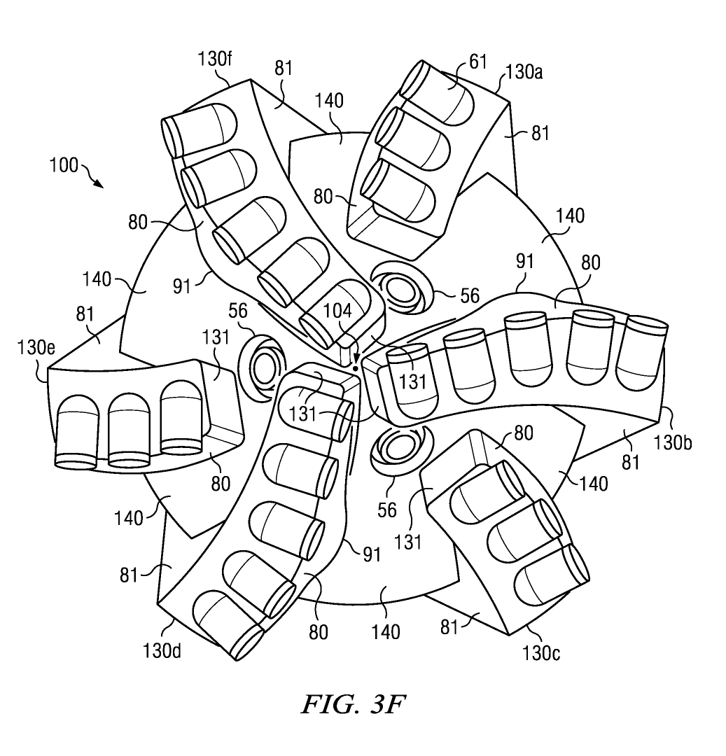

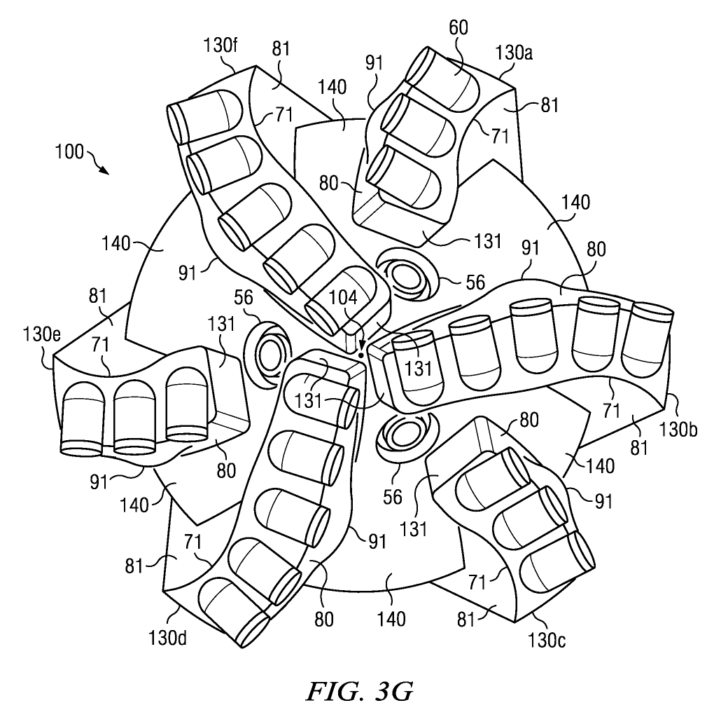

Bit body 120 may often be substantially covered by a mixture of drilling fluid, formation cuttings, and other downhole debris while drilling string 24 rotates rotary drill bit 100. Drilling fluid exiting from one or more nozzles 56 (see FIGS. 2 and 3A for some examples) may be directed to flow generally downwardly between adjacent blades 130 and flow under and around lower portions of bit body 120.

FIG. 2 is schematic drawings showing additional details of rotary drill bit 100 incorporating teachings of the present disclosure. Rotary drill bit 100 may include a bit body (not expressly shown) with a plurality of blades 130 (130a-130e) extending therefrom. For some applications, a bit body may be formed in part from a matrix of very hard materials associated with rotary drill bits. For other applications, a bit body may be machined from various metal alloys satisfactory for use in drilling wellbores in downhole formations. Examples of matrix type drill bits are shown in U.S. Pat. Nos. 4,696,354 and 5,099,929.

First end or uphole end 121 of bit body 120 may also include shank 42 with American Petroleum Institute (API) drill pipe threads 44 formed thereon. API threads 44 may be used to releasably engage rotary drill bit 100 with bottom hole assembly 26 whereby rotary drill bit 100 may be rotated relative to bit rotational axis 104 in response to rotation of drill string 24. Bit breaker slots 46 may also be formed on exterior portions of upper portion or shank 42 for use in engaging and disengaging rotary drill bit 100 from an associated drill string. An enlarged bore or cavity (not expressly shown) may extend from end 41 through shank 42 and into bit body 120. The enlarged bore may be used to communicate drilling fluids from drill string 24 to one or more nozzles 56.

Second end or downhole end 122 of bit body 120 may include a plurality of blades 130 with junk slots or fluid flow paths 140 disposed therebetween. Exterior portion of blades 130 and respective cutting elements 60 disposed thereon define in part an associate bit face profile disposed on exterior portion of bit body 120 proximate second end 122. One or more impact arrestors 160 (also known as abrasion elements) may be placed proximate a cutting element 60 on a blade 130. An impact arrestor (such as 160) may refer to any rounded element formed on the face of a drill bit typically placed on a side trailing the cutting surface of one or more cutting elements 60. Impact arrestors 160 may be placed on a blade at a common radius with at least one cutting element to allow an impact arrestor to travel in a groove cut by a cutting element. The placement of an impact arrestor is also driven by the amount of available space on the bit face on which an impact arrestor may be formed. Impact arrestors 160 may also be placed and distributed along gage, nose, or cone portions of a blade in a drill bit. Additional information concerning impact arrestors may be found in U.S. Pat. Nos. 6,003,623, 5,595,252 and 4,889,017. Blades 130 may spiral or extend from second end or downhole end 122 towards first end or uphole end 121 at an angle relative to exterior portions of bit body 120 and associated bit rotational axis 104.

An enlarged bore or cavity (not expressly shown) may be disposed in the bit body to communicate drilling fluids from drill string 24 to one or more nozzles. Junk slots or fluid flow paths 140 may be formed between adjacent blades 130. Fluid flow paths 140 formed in accordance with teachings of the present disclosure may have a wide variety of configurations including, but not limited to, helical, spiraling, tapered, converging, diverging, symmetrical, and/or asymmetrical. For some applications blades 130 may spiral or extend at an angle relative to an associated bit rotational axis 104.

Blade 130 of the present disclosure may comprise first end 131 disposed proximate or toward associated bit rotational axis 104 and second end 132 disposed toward exterior uphole portions of the rotary drill bit (i.e., disposed generally away from the bit rotational axis). Each blade 130 (also 130a-130e as shown in FIG. 2 and FIGS. 3A-3G and FIGS. 5A-5E), may comprise a leading surface 80 disposed on the side of blade toward the direction of rotation of the rotary drill bit and a trailing surface 81 disposed on the opposite side of the direction of rotation of the rotary drill bit. A plurality of junk slots 140 may each be disposed between a leading surface 80 of a blade and adjacent trailing surface 81 of an associated blade.

A plurality of cutting elements 60 may be disposed on exterior portions of each blade 130. For some applications, each cutting element 60 may be disposed in a respective socket or pocket formed on exterior portions of associated blades 130. Impact arrestors and/or secondary cutters 160 may also be disposed on each blade 130.

Cutting elements 60 may include respective substrates with respective layers 62 of hard cutting material disposed on one end of each respective substrate (see FIGS. 2, 3A-3G, and 5A-5E). Layer 62 of hard cutting material may also be referred to as “cutting layer” 62. Cutting surface 64 on each cutting layer 62 may engage adjacent portions of a downhole formation to form wellbore 31. Each substrate or surface may have various configurations and may be formed from tungsten carbide or other materials associated with forming cutting elements for rotary drill bits. Tungsten carbides include monotungsten carbide (WC), ditungsten carbide (W₂C), macrocrystalline tungsten carbide, and cemented or sintered tungsten carbide. Some other hard materials which may be used to form substrates 62 as well as cutting surfaces 64 include various metal alloys and cermets such as metal borides, metal carbides, metal oxides, and metal nitrides. For some applications, substrate 62 and cutting layers 64 may be formed from substantially the same materials. For some applications, substrate 62 and cutting layers 64 may be formed from different materials. In some embodiments, one or more of the materials may be hard cutting materials. Examples of such materials may include polycrystalline diamond materials including synthetic polycrystalline diamonds.

Various parameters associated with rotary drill bit 100 may include, but are not limited to, location, configuration, geometry, dimensions, and/or shape of blades 130, junk slots 140, cutting elements 60, and/or respective gage portion or gage pad 150 formed on each blade 130. For some applications gage cutters may also be disposed on each blade 130. Various parameters of rotary drill bit 100 may be used to design and/or modify various features and parameters of associated stabilizer 70 in accordance with teachings of the present disclosure including, but not limited to, the number, configuration, geometry, and/or dimensions of associated blades 130 and respective fluid flow paths 140.

For example, rotary drill bit 100 may often be substantially covered by a mixture of drilling fluid, formation cuttings, and other downhole debris while drill string 24 rotates rotary drill bit 100. Drilling fluid exiting from one or more nozzles 56 may be directed to flow generally toward end or bottom 36 or wellbore 30, to then flow under and around lower portions of rotary drill bit 50 and to then flow generally uphole between adjacent blades 52.

The number, location, and configuration of blades 130 and respective fluid flow paths 140 disposed on exterior portions of sleeve 70 may be designed and manufactured in accordance with teachings of the present disclosure to optimize drilling fluid flow between adjacent blades 130 disposed on associated rotary drill bit 100. One of the features of the present disclosure may include designing at least one blade based on parameters such as blade length, blade width, blade spiral, blade contour of associated leading surface and trailing surface, blade angle, and/or other parameters associated with each blade and/or associated junk slots.

Cutting elements and/or blades may be generally described as “leading” or “trailing” with respect to other cutting elements, blades, and components disposed on the exterior portions of an associated rotary drill bit, stabilizer, or other downhole tool. For example blade 130a of rotary drill bit 100 as shown in FIG. 2 can be said to lead blade 130b and trail blade 130e. In the same respect, cutting elements 60 disposed on blade 130a of rotary drill bit 100 may be described as leading corresponding cutting elements 60 disposed on blade 130b. Cutting elements 60 disposed on blade 130a may be generally described as trailing corresponding cutting elements 60 disposed on blade 130e.

Teachings of the present disclosure allow substantially varying the configuration, dimensions, geometry, and/or orientation of each blade and associated junk slots disposed on exterior portions of a rotary drill bit including, but not limited to, leading surfaces and trailing surfaces to optimize fluid flow over exterior portions of the associated cylindrical body.

An exemplary modification of blade configuration in accordance to the teachings of the present disclosure is shown in FIG. 3A where two secondary blades, 130b and 130e, extend inwards toward an associated bit-rotational axis, thereby splitting fluid flow through the junk slots 140. One or more of blades 130a-130e may also have one or more contours 71, such as a deep cut, on one or more of their trailing sides 81 as illustrated in FIG. 3A, thereby allowing for wider junk slots 140 and low velocity profile of fluids flowing therethrough. In some embodiments, a low velocity profile of fluids may approach a slow laminar flow. In some embodiments, modifications to blades in accordance with the teachings herein, may result in a substantially laminar flow of junk slot fluids.

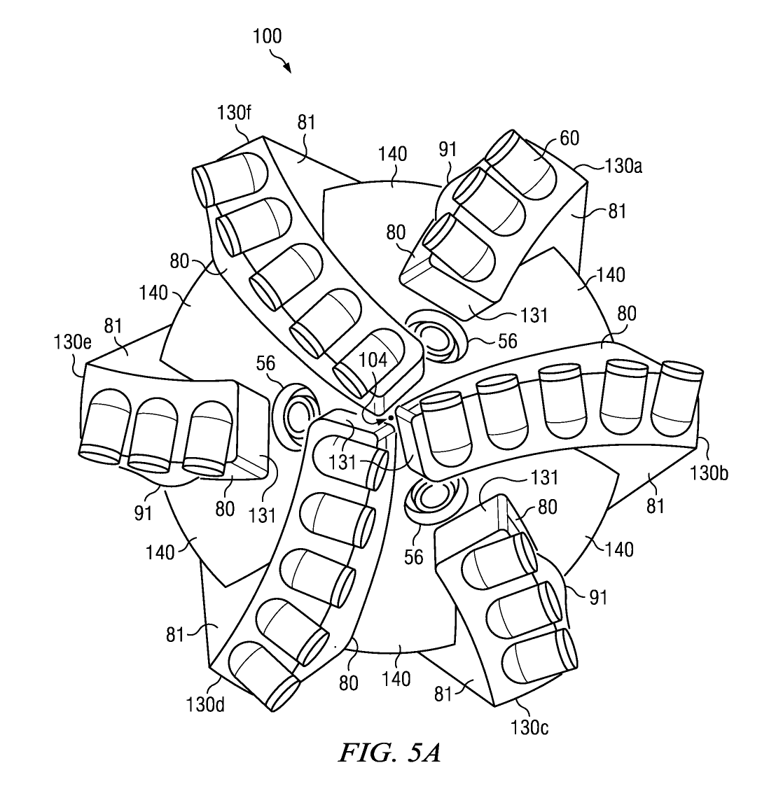

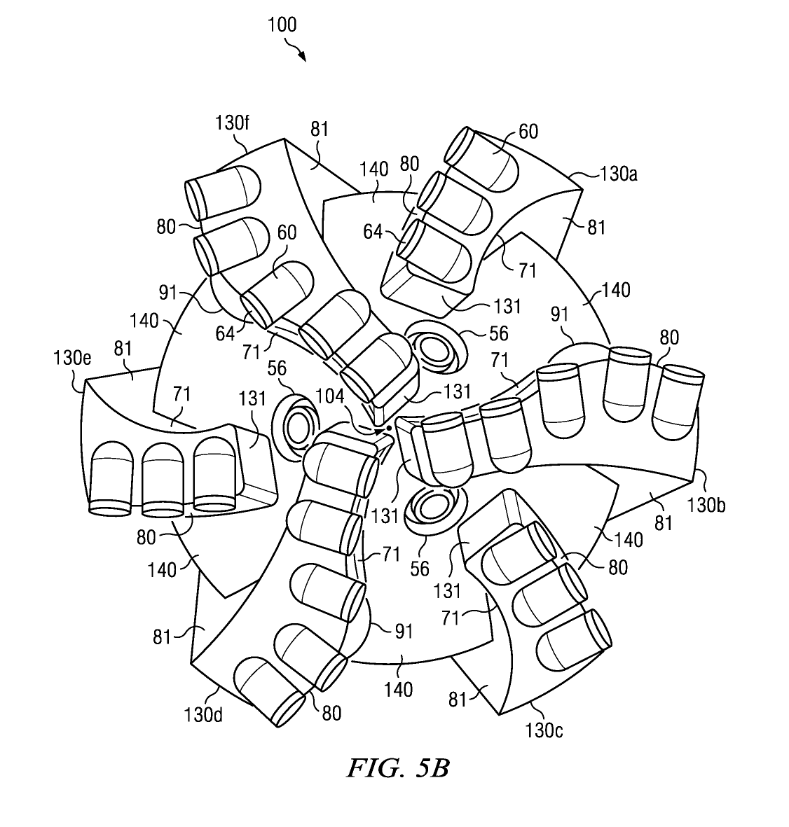

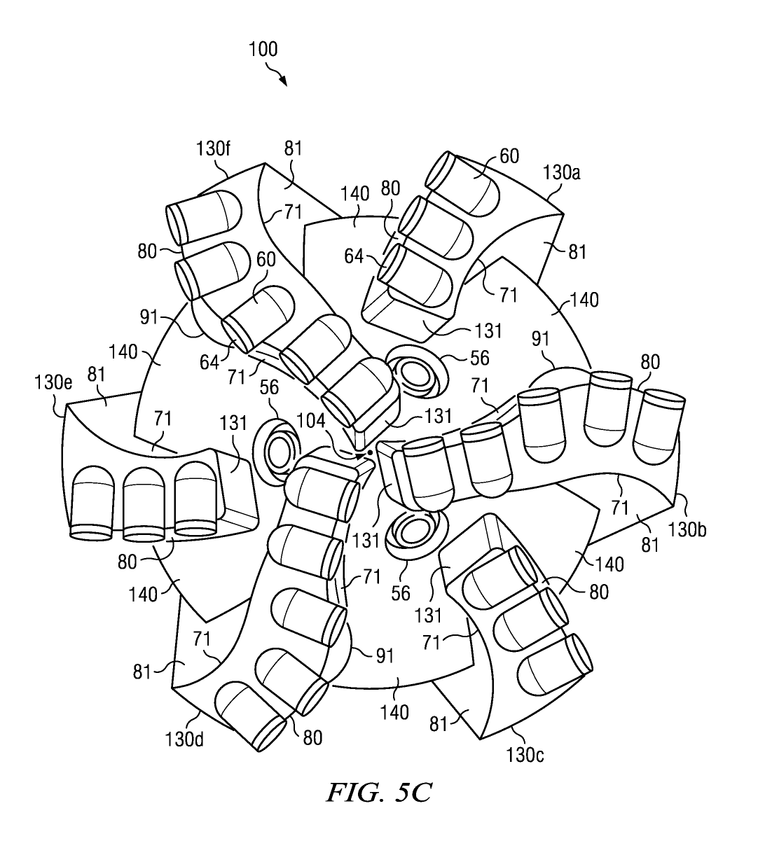

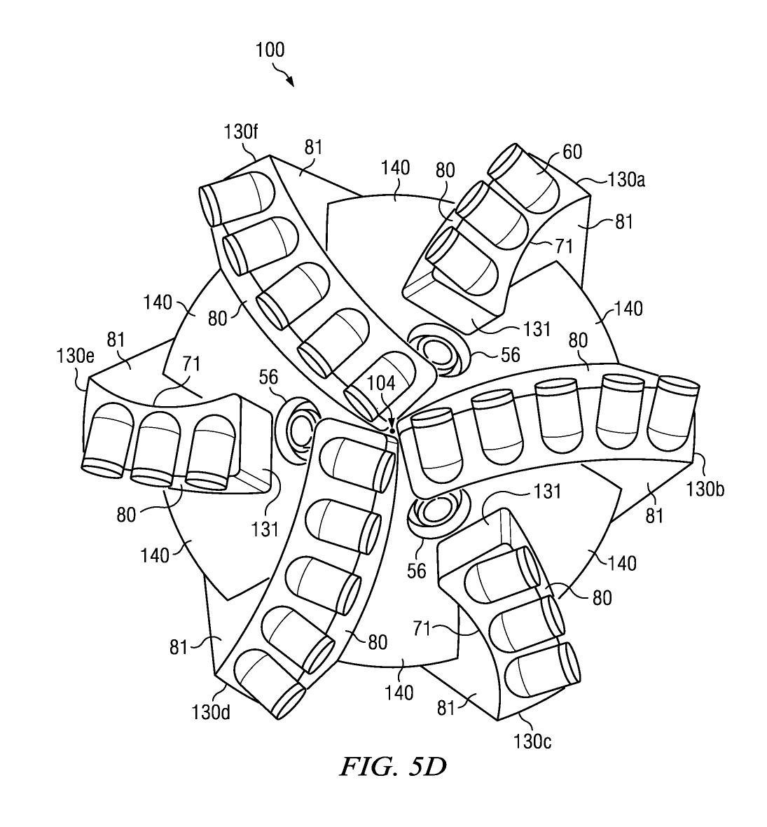

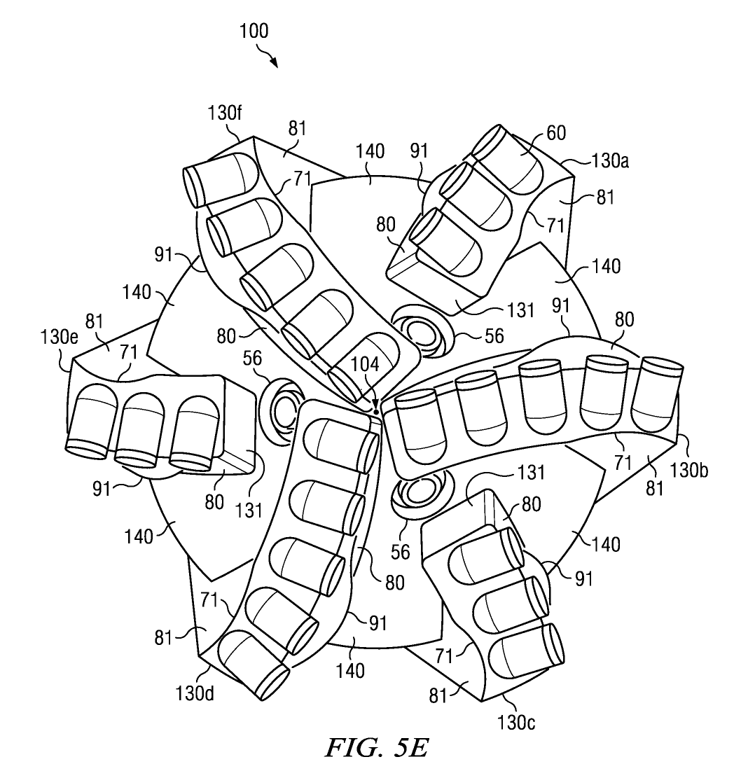

Other rotary drill bits showing exemplary modifications of blade configurations in accordance to the teachings of the present disclosure are illustrated in FIGS. 3A-3G and in FIGS. 5A-5E. Different angles, contours, dimensions, configurations, and/or geometries of blades 130 are depicted in these drawings which dispose junk slots 140 of different sizes and dimensions thereby changing and optimizing fluid flow in the respective junk slots, in accordance with the teachings herein. The teachings of the present disclosure are however not limited to these exemplary blade modifications.

FIG. 3A shows an end view of a rotary drill bit and exemplifies blade angles/geometry/configuration wherein two secondary blades 130e and 130b extend inwards toward an associated bit-rotational axis 104 to direct fluid flow in junk slots 140 and all blades 130a-130e have at least one contour 71 (exemplified in embodiments by: a cut, a deep cut, or a concave indentation) on at least one surface, such as the trailing surface, 81. Contours of different kinds may also be present on the leading surface of some or all primary and/or secondary blades at one or more locations.

FIG. 3B exemplifies a rotary drill bit formed in accordance with the teachings herein with blade angles/geometry/configuration wherein two secondary blades 130e and 130b extend inwards toward an associated bit rotational axis 104 to direct fluid flow in junk slots 140 and all blades 130a-130e have at least one contour 71 (exemplified in embodiments by: a curve, a cut, a deep cut, or a concave indentation) on at least one surface, such as the trailing surface 81 and at least one contour 91 (exemplified in embodiments by a protrusion such as a hump, a convex projection, or an extension) on at least the leading surface 80.

In FIGS. 3C-3G and 5A-5E, blades 130b, 130d and 130f, extend inwards toward the center (bit rotational axis) thereby splitting fluid flow through junk slots 140. In some of these embodiments, extended blades 130b, 130d, and 130f may function as diffusers that modify and optimize the flow of fluid through the nozzles 56.

In an exemplary configuration shown in FIG. 3C, three secondary blades 130b, 130d and 130f extend inwards toward an associated bit-rotational axis 104 to direct fluid flow in junk slots 140 and all blades 130a-130e have at least one contour 91 (exemplified in embodiments by a protrusion such as a hump, a convex projection, or an extension) on at least one surface, such as the leading surface 80. In one embodiment of FIG. 3C, blades 130b, 130f, and 130d may function as diffusers to nozzles 56. In some embodiments contour 91 in FIG. 3C may be a protrusion such as a hump, a convex projection, or an extension. Other types of contours may also be disposed on leading surface 80 or on the trailing surface 81 (not expressly shown).

FIG. 3D illustrates another example orientation of blade angles/geometry/configuration, in accordance with the present disclosure, wherein three secondary blades 130b, 130d, and 130f extend inwards toward an associated bit rotational axis 104 and may function as diffusers to nozzle 56 to direct fluid flow.

FIG. 3E exemplifies a rotary drill bit formed in accordance with the teachings of this disclosure showing an example orientation of blade angles, geometry, configuration, and/or dimensions wherein secondary blades such as 130b, 130d, and 130f extend inwards toward an associated bit-rotational axis 104 to direct fluid flow in junk slots 140. In some embodiments, one or more of blades 130b, 130d, and/or 130f may function as a diffuser to nozzles 56. Additionally, all blades 130a-130e have at least one contour 71 (exemplified in embodiments by: a cut, a curve, a deep cut, or a concave indentation) on at least one surface, such as the trailing surface 81. Other types of contours may also be disposed on leading surface 80 or on trailing surface 81 (not expressly shown).

Another embodiment of blade angles and/or geometry and/or configuration is depicted in FIG. 3F wherein secondary blades such as 130b, 130d, and 130f extend inwards toward an associated bit-rotational axis 104 to direct fluid flow in junk slots 140. In some embodiments, one or more of the secondary blades 130b, 130d, and/or 130f may function as a diffuser to nozzles 56. Each secondary blade may have at least one contour 91 on at least one surface, such as the leading surface 80. Contour 91 may be a protrusion such as a hump, a convex projection, or an extension, or an incline as shown. However, other types of contours as set forth herein may also be formed on the leading surface 80 (not expressly shown). In some embodiments primary blades may also have one or more contours on them (not expressly shown).

Yet another embodiment of blade angles and/or geometry and/or configuration is depicted in FIG. 3G which shows an end view of a rotary drill bit with secondary blades such as 130b, 130d, and 130f extending inwards toward an associated bit rotational axis 104 and that may function as diffusers to nozzle 56 and/or direct fluid flow. Each blade 130a-130f may have at least one contour 91 on the leading surface 80 (such as a protrusion such as a hump, or a convex extension or projection as depicted or other types of contours not expressly depicted). Each blade also may have at least one contour 71 on the trailing surface 81 (such as a curve, a cut, a deep cut, or a concave indentation as depicted, although other types of contours not expressly depicted in this drawing may also be present in accordance with the teachings of this disclosure).

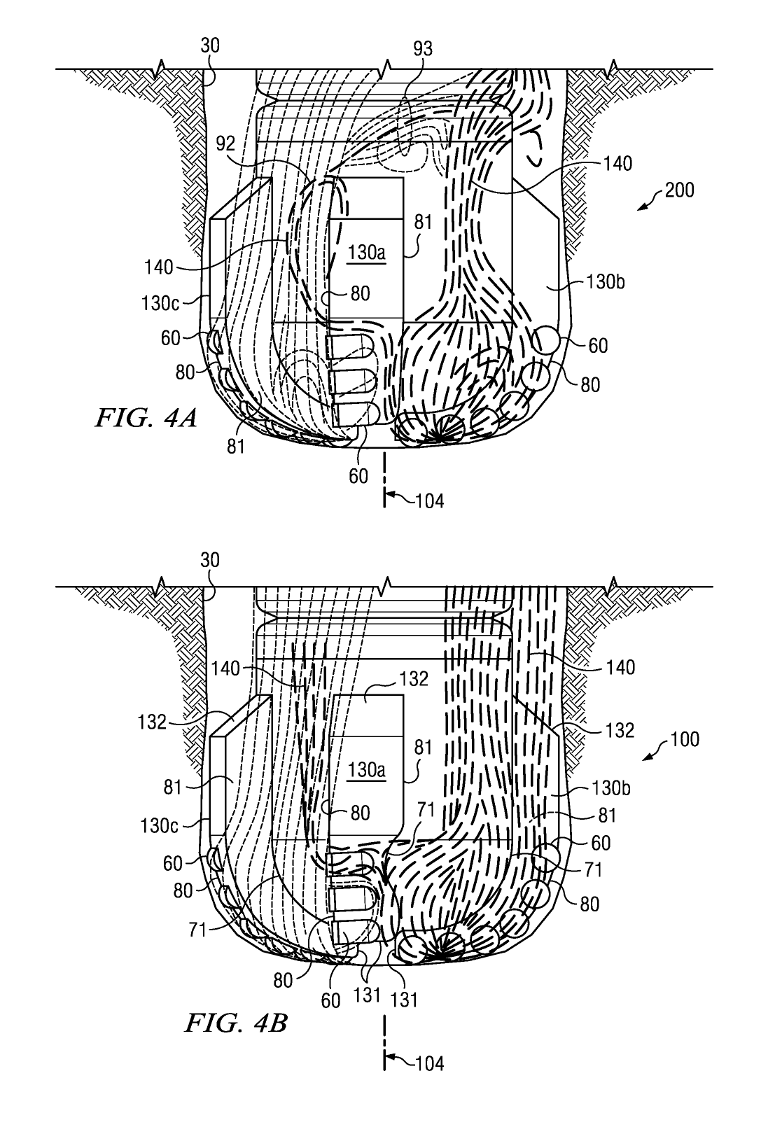

Various fluid flow models and fluid flow software applications may be used to simulate resulting fluid flow characteristics. Flow restrictions or “pinch points” associated with a trailing surface (as depicted in the FIG. 4A) associated with rotary drill bit 200 may be substantially reduced or eliminated by designing blades 130 and associated fluid flow paths 140 in accordance with teachings of the present disclosure. FIG. 4A shows a schematic of a computational fluid dynamic (CFD) modeling showing one example of flow patterns associated with junk slots 140. Turbulent fluid flow in regions 92 and/or 93 may result from restriction associated with trailing surface 81 of blade 130a and leading surface 80 of blade 130b.

FIG. 4B shows a schematic of a computational fluid dynamic (CFD) modeling showing improved fluid flow patterns resulting from configuration and geometric design changes to blades 130a-c in a drill bit incorporating teachings of the present disclosure. Rotary drill bit 100 may include blades 130a-130c modified with respective recessed portions such as cutouts or other contours 71 formed in trailing surfaces 81. As a result, more organized and less turbulent fluid flow paths 140 may be formed by cooperation between recessed portion (contour) 71 in trailing surface 81 of blade 130a and leading surface 80 of blade 130b. See, for example, FIG. 4B. Modifying blades 130a-c with respective contour 71 modifies junk slots 140 to be wider at certain locations proximate contour 71 thereby eliminating or reducing pinch points as in the drill bit depicted in FIG. 4A. Optimization of fluid flow in accordance with the teachings of the present disclosure allows for optimized and/or streamlined flow of drilling fluids that may be used to reduce erosion caused by turbulence of drilling mud and/or used to direct fluid flow to structures on a drill bit that require cleaning.

For example, in FIG. 4B, streamlined flow may be used to clean cutters 60 and other parts of blades, and may be used to lift up cuttings trapped or deposited in between blades (such as between 130b and 130a, or between 130a and 130c) to the top of the wellbore. Reducing erosion may enhance the life of a drill bit. Better cleaning and removal of downhole debris may improve general downhole performance.

FIG. 5A shows an end view of a rotary drill bit depicting an example configuration wherein the first end 131 of three blades, 130b, 130d, and 130f, extends inward toward the bit rotational axis 104 of a drill bit. In some embodiments, extended blades 130b, 130d, and 130f may be formed to protrude, curve, and/or angle toward nozzles 56 and function as diffusers that modify and optimize the flow of fluid through the nozzles 56. In some embodiments, blades 130b, 130d, and 130f may also have one or more contours on one or more surfaces (not expressly shown). Contour 91 may be a protrusion such as a hump or a convex projection as depicted or may be other types of contours described herein but not expressly depicted. Additionally, Blades 130a, 130c, and 130e may also have a contour disposed on leading surface 80 (not expressly shown) or on trailing surface 81 (not expressly shown).

In some embodiments shown in FIGS. 5A-5E, one or more such blades (such as 130b, 130d, and 130f) may be joined at or near the bit rotational axis 104, at first ends 131, to modify fluid flow through the junk slots 140 (not expressly depicted). In FIG. 5B, an example configuration of blade modifications on drill bits, in accordance with the teachings of the present disclosure, is shown wherein secondary blades 130b, 130d, and 130f are extending toward an associated bit rotational axis 104 to improve fluid flow through junk slots 140, and each secondary blade has at least one contour 71 (depicted as a curve, cut, deep cut, or concave indentation, but not limited to the depicted embodiments) on the leading surface 80 toward the first end of the blade 131 and at least one contour 91 (depicted as a protrusion such as a hump or convex projection, but not limited to the depicted embodiments) on the same leading surface 40 generally away from the first end 131 and generally toward the second end 132 of the blade. In some embodiments, the primary blades 130a, 130c, and 130e may have at least one contour 71 (depicted as a curve, or cut, or deep cut, or concave indentation, but not limited to the depicted embodiments) on the trailing surface 81.

One embodiment depicted in FIG. 5C shows an example configuration of blade modifications on a drill bit, in accordance with the teachings of the present disclosure, wherein secondary blades 130b, 130d, and 130f are extending toward an associated bit rotational axis 104 to improve fluid flow, and each secondary blade has at least one contour 71 (depicted herein as a curve, cut or deep cut, or concave indentation, but not limited to the depicted contour types) on the leading surface 80 toward the first end of the blade 131 and at least one contour 91 (depicted herein as a protrusion such as a hump or convex projection, but not limited to the depicted contours) also on the leading surface 80 away from the first end 131 and toward the second end 132 of the blade. Furthermore, all the blades 130a-130f may have at least one contour 71 on the trailing surface (depicted herein by a curve, cut or deep cut, or concave indentation, but not limited to these contours).

FIG. 5D depicts an embodiment of an example configuration of blade modifications on a drill bit, in accordance with the teachings of the present disclosure, wherein secondary blades 130b, 130d, and 130f are extending toward an associated bit rotational axis 104 and first ends 131 of these blades may be joined at the center (i.e., at or near the bit rotational axis 104) to optimize fluid flow patterns in junk slots 140. In some embodiments, the secondary blades act as diffusers to the nozzles 56. In some embodiments, primary blades such as blades 130a, 130c, and 130e may have a contour 71 on the trailing surface 81, and/or on the leading surface 80 (not expressly shown).

FIG. 5E shows another example embodiment of blade angles/geometry/contours of a drill bit and depicts a configuration wherein secondary blades 130b, 130d, and 130f are extending toward the center and an associated bit rotational axis 104. In some embodiments, these blades may be making contact at the first end 131 of the blade to improve fluid flow and/or may function as diffusers to the nozzles 56. Each blade may have at least one contour 71 on the trailing surface 80 (for example, but not limited to a curve, cut or deep cut, or concave indentation) and at least one contour 91 (for example, but not limited to a protrusion such as a hump or a convex projection) on the leading surface 80.

Some embodiments may comprise a drill bit with each blade having at least one contour (such as, but not limited to, a curve, or cut, or deep cut, or concave indentation) on the leading or trailing surface and at least one contour (such as, but not limited to, to a protrusion such as a hump or convex extension) on the leading or trailing surface or on both surfaces at one or more locations.

Any contour 71 or 91 or other geometric change as described in the present disclosure may be formed on optimum locations such as locations on blades determined by CFD simulation programs to be areas that may be modified in accordance to the teachings herein to obtain optimum fluid flows. Such contours may be formed on at least one location of a trailing surface 81, at least one location of a leading surface 80, and/or on at least one location each of both the leading surface 80 and the trailing surface 81 of one or more blades.

Changing blade configurations, angles, and/or geometries at one or more locations and/or surfaces in accordance to the teachings of the present disclosure may improve fluid flow patterns preventing erosion of drill bit parts and improving downhole performance.

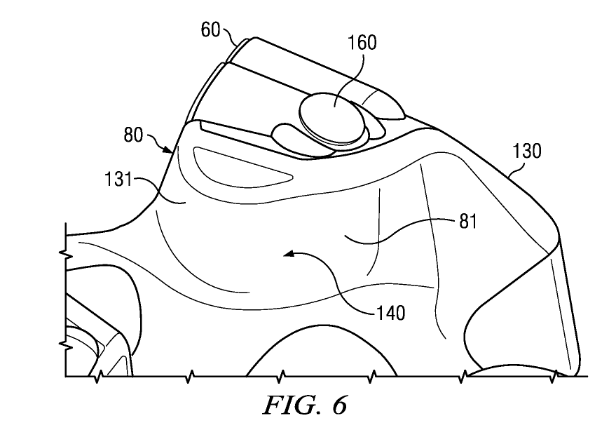

FIG. 6 depicts projection of a blade toward the bit rotational axis or center of a drill bit by angling the blade, i.e., by changing the angle at which a blade is disposed on a drill bit. Such angling of the blade may change the geometry of the blade and may also optimize fluid flow patterns through junk flow slots 140. One or more impact arrestors 160 may also be placed proximate cutting elements 60 on blade 130.

Teachings of the present disclosure may be used to optimize the design of various features of a drill bit including, but not limited to, the number of blades, dimensions, configuration, and geometry of each blade along with the configuration, geometry, dimensions, location, and/or orientation of fluid flow paths extending between adjacent blades. The number, dimensions, location, and/or orientation of one or more nozzles 56 disposed on an associated bit body may be varied in accordance with teachings of the present disclosure.

Fluid flow paths 140 may be disposed between blades 130 to establish a fluid flow to optimize removal of formation cuttings and other downhole debris. In some embodiments, methods for obtaining optimized fluid flow patterns may comprise identifying locations on one or more blades 130 for changing the geometry, angle, orientation, or configuration such that a junk flow slot 140 may have a configuration that allows for optimized fluid flow. Locations may be identified using CFD programs and/or simulations to predict fluid flow using different blade configurations.

Optimizing fluid flow paths of a rotary drill bit may be achieved by performing computational fluid dynamics (CFD) program simulations to determine one or more optimum locations that may be modified on at least one blade. The geometry, configuration, location, orientation, and/or contour of at least one blade at one or more determined optimum locations may be then modified. Another CFD simulation may then be run with the modified blade to analyze fluid flow paths. This process may be repeated until optimized fluid flow paths are obtained. In some embodiments, at least one CFD program simulation may be performed after a blade modification to verify that the modification results in optimized fluid flow.

In some embodiments, a method may comprise performing one or more computational fluid dynamics (CFD) simulations to determine one or more optimum locations on a blade to install a diffuser and/or modify a blade to form a diffuser adjacent to a nozzle 56. One or more diffusers may then be formed and/or installed at the determined optimum locations. Changes in the fluid flow patterns may be analyzed by CFD simulations and the process may be repeated until an optimized fluid flow is obtained.

In some embodiments, a method for determining optimum fluid flow in a drill bit may comprise performing CFD simulations to determine optimum locations for changing blade geometry as well as performing CFD simulations to determine optimum locations for forming and/or installing diffusers adjacent to nozzles and changing blade geometry/orientation/configuration/contour as well as placing diffusers, thereby optimizing fluid flow.

The location, configuration, orientation, and/or dimensions of each blade and associated fluid flow paths may be modified based, at least in part, on CFD simulations and analysis of wear patterns on corresponding used rotary drill bits or other well tools. Width, height, length, configuration, and/or orientation of blades and associated fluid flow paths disposed on exterior portions of such rotary drill bit and/or other downhole tools may also be optimized to enhance downhole drilling performance with respect to removing formation materials, cuttings, and other downhole debris from the end of a wellbore. Optimizing fluid flow may reduce erosion, abrasion, and/or wear of blades.

Modifications, additions, or omissions may be made to the systems and apparatuses described herein without departing from the scope of the invention. The components of the systems and apparatuses may be integrated or separated. Moreover, the operations of the drill bit may be performed by more, fewer, or other components. Additionally, operations of the systems and apparatuses may be performed using any suitable logic comprising software, hardware, and/or other logic. As used in this application, “each” refers to each member of a set or each member of a subset of a set.

Modifications, additions, or omissions may be made to the methods described herein without departing from the scope of the invention. The method may include more, fewer, or other steps. Additionally, steps may be performed in any suitable order.

A component of the systems and apparatuses described herein may be configured to be operable to perform an operation. A component may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1. A rotary drill bit comprising:
a bit body with a bit rotational axis extending through the bit body;
a plurality of blades disposed outwardly from a plurality of exterior portions of the bit body;
a plurality of cutting elements disposed outwardly from a plurality of exterior portions of each blade;
at least one of the blades having a substantially arched configuration;
each blade comprising a leading surface and a trailing surface, the leading surface disposed on the side of the blade toward the direction of rotation of the rotary drill bit, the trailing surface disposed on the side of the blade opposite to the direction of rotation of the rotary drill bit;
a plurality of junk slots, each of the junk slots disposed between an adjacent leading surface and an adjacent trailing surface of associated blades; and
at least one blade having at least one contour formed on a portion of at least one of the locations selected from a group consisting of the leading surface of the blade, the trailing surface of the blade, and both the leading surface and the trailing surface of the blade.

2. The rotary drill bit of claim 1, the blades comprising a plurality of primary blades and at least one secondary blade, the at least one secondary blade disposed between primary blades.

3. The rotary drill bit of claim 1, the contour comprising: a protrusion, a recess, a slope, or combinations thereof.

4. The rotary drill bit of claim 1, the at least one blade further comprising:
at least one of the leading surface or the trailing surface disposed substantially in a plane; and
the contour comprising a deviation from the plane at a portion of at least one of the leading surface or the trailing surface of the blade.

5. The rotary drill bit of claim 1, the at least one blade further comprising a protrusion operable to optimize fluid-flow through an associated junk slot.

6. The rotary drill bit of claim 5, the protrusion proximate to a nozzle.

7. The rotary drill bit of claim 6, the protrusion operating as a diffuser to the nozzle.

8. A rotary drill bit comprising:
a bit body with a bit rotational axis extending through the bit body;
a plurality of blades disposed outwardly from a plurality of exterior portions of the bit body;
a plurality of cutting elements disposed outwardly from a plurality of exterior portions of each blade;
at least one of the blades having a substantially arched configuration;
each blade comprising a leading surface and a trailing surface, the leading surface disposed on the side of the blade toward the direction of rotation of the rotary drill bit, the trailing surface disposed on the side of the blade opposite to the direction of rotation of the rotary drill bit;
a plurality of junk slots, each of the junk slots disposed between an adjacent leading surface and an adjacent trailing surface of associated blades; and
at least one blade having at least one extension extending therefrom at an optimum location, the extension operable to optimize fluid-flow through an associated junk slot.

9. The rotary drill bit of claim 8, the blades comprising a plurality of primary blades and at least one secondary blade, the at least one secondary blade disposed between primary blades.

10. The rotary drill bit of claim 8, the extension proximate to a nozzle.

11. The rotary drill bit of claim 8, the extension operating as a diffuser, the diffuser operable to optimize fluid-flow through the associated junk slot.

12. The rotary drill bit of claim 8, the at least one blade further comprising at least one contour, the contour located on the blade on at least one of the locations selected from a group consisting of: the leading surface of the blade, the trailing surface of the blade, and both the leading surface and the trailing surface of the blade.

13. The rotary drill bit of claim 12, the contour comprising: a protrusion, a recess, a slope, or combinations thereof.

14. A rotary drill bit comprising:
a bit body with a bit rotational axis extending through the bit body;
a plurality of blades disposed outwardly from a plurality of exterior portions of the bit body;
a plurality of cutting elements disposed outwardly from a plurality of exterior portions of each blade;
at least one of the blades having a substantially arched configuration;
each blade comprising a leading surface and a trailing surface, the leading surface disposed on the side of the blade toward the direction of rotation of the rotary drill bit, the trailing surface disposed on the side of the blade opposite to the direction of rotation of the rotary drill bit;
a plurality of junk slots, each of the junk slots disposed between an adjacent leading surface and an adjacent trailing surface of associated blades;
at least one nozzle disposed in at least one junk slot;
at least one diffuser located on at least one of the blades proximate a nozzle, the diffuser operable to optimize fluid-flow through an associated junk slot; and
at least one blade having at least one contour formed on a portion of at least one of the locations selected from a group consisting of the leading surface of the blade, the trailing surface of the blade, and both the leading surface and the trailing surface of the blade.

15. (canceled)

16. The rotary drill bit of claim 14, the contour comprising: a protrusion, a recess, a slope, or combinations thereof.

17. The rotary drill bit of claim 14, the diffuser operable to direct fluid flow in a direction chosen from the group consisting of: into a junk slot, away from a junk slot, towards a cutting element, away from a cutting element, towards a cutting surface, away from a cutting surface, towards a blade, away from a blade, and combinations thereof.

18. A method for optimizing fluid flow in a rotary drill bit comprising:
determining at least one optimum location that may be modified on at least one blade of the rotary drill bit by performing at least one computational fluid dynamics (CFD) program simulation;
modifying the at least one blade at the at least one optimum location to yield at least one modified blade, the modification modifying at least one dimension of at least one junk slot disposed between the modified blade and a blade adjacent to the modified blade to yield at least one modified junk slot, the modification changing the fluid flow pattern in the modified junk slot to optimize fluid flow of the drill bit; and
introducing a contour at the at least one optimum location of the blade.

19. The method of claim 18, the modifying the at least one blade selected from a group consisting of:
changing a configuration of the blade;
changing at least one dimension of the blade;
changing a geometry of the blade;
changing an orientation of the blade; and
any combination thereof.

20. The method of claim 18, the modifying the at least one blade comprising:
introducing a contour at the at least one optimum location of the blade.

21. The method of claim 20, the contour comprising:
a protrusion, a recess, a slope, or combinations thereof.

22. (canceled)

23. The method of claim 18, the modifying the at least one blade comprising:
changing an angle at which a blade is disposed at the at least one optimum location of the blade.

24. The method of claim 18, further comprising:
performing at least one additional CFD program simulation to determine at least one additional optimum location that may be modified on the at least one blade; and
modifying the at least one blade at the determined at least one additional optimum location.

25. The method of claim 18, further comprising:
performing at least one additional CFD program simulation to confirm that modifying the at least one blade yields optimized fluid flow.

26. The method of claim 18, the at least one CFD program simulation taking into account at least one of the following: a size of a fluid pump, a size of the rotary drill bit, and a quantity of nozzles on the rotary drill bit.

27. The method of claim 18:
the determining at least one optimum location comprising a location proximate a nozzle; and
the modifying at least one blade comprising:
forming at least one diffuser at the location proximate the nozzle, the diffuser operable to optimize fluid-flow through a modified junk slot.

28. The method of claim 18, the modifying the at least one blade comprising:
modifying at least one blade to protrude toward a nozzle to form a diffuser, the diffuser operable to optimize fluid-flow through a modified junk slot.

29. The method of claim 18, the modifying at least one blade comprising:
forming at least one diffuser at the at least one optimum location, the diffuser operable to optimize fluid-flow through a modified junk slot.

30. The method of claim 18, further comprising:
analyzing at least one wear pattern of a used rotary drill bit to determine the at least one optimum location.

31. The method of claim 18, further comprising:
analyzing at least one erosion pattern of a used rotary drill bit to determine at least one location on the drill bit that is subject to erosion; and
the modifying the at least one blade comprising:
modifying the at least one blade to reduce erosion of the at least one location that is subject to erosion.

32. The method of claim 18, further comprising:
performing erosion analysis on a used rotary drill bit to determine at least one location on an exterior portion of the rotary drill bit that accumulates downhole debris.

33. The method of claim 18, the modifying the at least one blade comprising:
modifying the at least one blade to reduce downhole debris accumulation of at least one location of the rotary drill bit.

34. The method of claim 18, the modifying the at least one blade comprising:
modifying the at least one blade to:
direct fluid flow to a location of the at least one blade, re-direct fluid flow to the location, increase fluid flow to the location, increase pressure of fluid flow to the location, increase volume of fluid flow to the location, divert fluid flow to the location, mobilize fluid flow from a junk slot associated with the modified blade, wash away accumulated debris, direct fluid flow from the junk slot, increase the pressure of fluid flow in the junk slot, increase the volume of fluid flow in the junk slot, decrease fluid flow in the junk slot, or any combinations thereof.

35. The method of claim 18, further comprising:
analyzing at least one downhole debris accumulation pattern of a test drill bit tested in a field having at least one specific borehole characteristic.

36. The method of claim 18, further comprising:
rendering at least one location of downhole debris deposition less prone to debris deposition.

37. The method of claim 18, further comprising:
rendering at least one location of downhole debris accumulation substantially free of debris accumulation.

38. The method of claim 18, the modifying the at least one blade comprising:
modifying the at least one blade to facilitate cleaning of at least one second location of the rotary drill bit.

39. The method of claim 38, the at least one second location comprising at least one cutting element of the rotary drill bit.

40. The method of claim 18, the at least one optimum location comprising a location proximate a nozzle; and
the modifying the at least one blade comprising:
forming a diffuser at the location proximate the nozzle to change a fluid flow pattern in a junk slot adjacent to the at least one blade to facilitate cleaning of the rotary drill bit.

41. The method of claim 18, the modifying the at least one blade comprising:
modifying the at least one blade to facilitate formation cutting lifting of the rotary drill bit.
